(19) United States
(12) Patent Application Publication
(10) Pub. No.: US 2026/0204762 A1
(43) Pub. Date: Jul. 16, 2026

(54) TM MODE RESONATOR STRUCTURE AND FILTER COMPRISING THE SAME

(71) Applicant: Telefonaktiebolaget LM Ericsson (publ), Stockholm (SE)

(72) Inventors: Juandi SONG, Beijing (CN); Jichuan ZHANG, Stockholm (SE); Jingpeng LI, Beijing (CN)

(21) Appl. No.: 19/132,583

(22) PCT Filed: Dec. 6, 2022
(86) PCT No.: PCT/CN2022/136836

§ 371 Date: May 23, 2025

(51) Int. Cl. H01P 1/208; H01P 1/20; H01P 7/10

(52) U.S. Cl. CPC H01P 1/2086; H01P 1/2002; H01P 7/105

(57) ABSTRACT

A TM mode resonator structure having at least two kinds of dielectric materials having different dielectric constants, wherein a first part of a first dielectric material constitutes a first resonator, which is surrounded by a second part of at least a second dielectric material, wherein the dielectric constant of the first dielectric material is greater than the dielectric constant of the second dielectric material; The first and second parts are bonded with each other into a single piece, the outer surface of which is coated with a metal material. The present disclosure further relates to a filter having the above-mentioned TM mode resonator structure, and a duplexer and a radio device comprising such a filter. The filter of the present disclosure can be widely used in AAS systems.

### TECHNICAL FIELD

The present disclosure generally relates to the technical field of communication, and particularly to a TM mode resonator structure and a filer comprising the same.

### BACKGROUND

This section introduces aspects that may facilitate better understanding of the present disclosure. Accordingly, the statements of this section are to be read in this light and are not to be understood as admissions about what is in the prior art or what is not in the prior art.

Base station (BS) is an important part of a mobile communication system, and may include a radio unit (RU) and an antenna unit (AU). Considering the installation/fixation/occupation, smaller volume and lighter weight is always an important evolution direction in BS design, including legacy base station, street macro, micro, small cell and advanced antenna system (AAS).

With the development of advance radio system, the need for a smart radio with high performance and a small size is growing rapidly. Highly integrated AAS system with multi-channels is developing rapidly in recently years. Highly integrated macro system with multi-bands is also under development. In those radio systems, RF filter is one important part for selecting a desired frequency and resisting the undesired frequency spurious of the system.

In AAS systems, both metal and ceramic waveguide (CWG) filter are widely used. Metal filters can provide a satisfactory insertion loss (IL) and power handling, and can be produced with mature material and production process, which is thus widely used in AAS systems. In order to achieve a AAS system with a smaller size and a lower weight, several measures have be taken to minimize the size and weight of a metal filter, such as adopting a soldering lid, a sheet metal, and using a semi-solid die casting. However, due to the limitation in the mechanical processing, the size and weight of the metal filter cannot be reduced further. As compared with the metal filter, a ceramic filter can achieve a smaller size, and can be easily integrated with a radio system by SMT process. Further, the thickness of the radio system can be greatly reduced by using such a ceramic filter, and the number of RF connectors can be reduced by a simple SMT process. However, the CWG filters have limitation in Q value and loss.

A TM mode filter comprising a ceramic resonator in a metal chassis is under development for macro radio system. It includes a single-end grounding solution, a two-end grounding solution, and dual-mode solution, which can achieve a reduced filter size as compared with the metal filter, and also gain an improved Q value and filter loss. The two-end grounding solution is most attractive in size and performance. But since the ceramic part is very sensitivity in mechanical force and thermal force, this kind of filter cannot be widely used. Although compared with the current CWG solution, the TM mode solution can achieve a greatly improved Q value, the size thereof cannot be further reduced to meet the requirements of AAS.

Therefore, a small size onboard filter with a greater Q value and a lower IL is in need for ASS system.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide a filter, which can achieve a smaller size while ensuring a good filter performance.

According to a first aspect of the disclosure, there is provided a TM mode resonator structure comprising at least two kinds of dielectric materials having different dielectric constants, wherein a first part of a first dielectric material constitutes a first resonator, which is surrounded by a second part of at least a second dielectric material, wherein the dielectric constant of the first dielectric material is greater than the dielectric constant of the second dielectric material, the first and second parts being bonded with each other into a single piece, the outer surface of which is coated with a metal material.

In an embodiment of the disclosure, the at least two kinds of dielectric materials are ceramic materials.

In an embodiment of the disclosure, an upper end face and/or a lower end face of the first part is/are formed as part of the outer surface of the single piece and coated with the metal material, so as to achieve a single-end grounding or a two-end grounding.

In an embodiment of the disclosure, a recess coated with the metal material is provided on an upper end face and/or a lower end face of the single piece.

In an embodiment of the disclosure, the recess is formed in the first part and/or the second part.

In an embodiment of the disclosure, the first part is recessed at the upper and/or lower end relative to the second part to form the recess, the recess being delimited by the first and second parts.

In an embodiment of the disclosure, the metal material on an upper end face and/or an lower end face of the single piece is partially removed to form a metal-free region.

In an embodiment of the disclosure, a cross-section of the first part as the first resonator has a shape selected from a circle, a polygon, or a cross.

In an embodiment of the disclosure, it further comprises a second resonator, wherein the second resonator and the first resonator are substantially orthogonal to each other. The second resonator is made of a material which is the same as or different from the first dielectric material.

In an embodiment of the disclosure, it further comprises a third resonator, the first, second and third resonators being substantially orthogonal to one another. The third resonator is made of a material which is the same as or different from the first dielectric material. The metal material is silver or copper.

According to a second aspect of the disclosure, there is provided a filter, comprising a plurality of TM mode resonator structures as mentioned above and two ceramic waveguide structures, adjacent two of the TM mode resonator structures and ceramic waveguide structures being coupled with each other via a coupling window, wherein a first ceramic waveguide structure serves as a signal feed-in and a second ceramic waveguide structure serves as a signal feed-out.

In an embodiment of the disclosure, a metallic shield is disposed over an upper end face of the filter. The ceramic waveguide structures and the TM mode resonator structures are in a linear arrangement, the plurality of TM mode resonator structures being located between the first and second ceramic waveguide structures.

In an embodiment of the disclosure, the filter comprises at least two rows of TM mode resonator structures coupled via a connecting portion, wherein the first ceramic waveguide structure is coupled with one of a first row of TM mode resonator structures and the second ceramic waveguide structure is coupled with one of a second row of TM mode resonator structures.

According to a third aspect of the disclosure, there is provided a duplexer comprising at least one filter as mentioned above.

According to a fourth aspect of the disclosure, there is provided a radio device comprising a filter as mentioned above.

In an embodiment of the disclosure, the filter is attached to a PCB by SMT.

The structural design of the present disclosure can at least bring the following benefits: a simple and compact structure; a reduced assembly complexity; and an improved performance with a greater Q value and a lower insertion loss.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 schematically shows a single resonator structure comprised in a prior art TM mode filter in a sectional view;

FIG. 2 schematically shows a prior art TM mode filter in a sectional view;

FIG. 3 schematically shows a prior art CWG filter in a perspective view;

FIG. 4 schematically shows a TM mode resonator structure according to an embodiment of the present disclosure in a perspective view and a sectional view;

FIGS. 5 and 6 schematically show TM mode resonator structures with various structural forms in sectional views, wherein the metal material on an upper end face and/or an lower end face of the structure is partially removed to form a metal-free region for tuning;

FIG. 7 schematically shows a metallic shield disposed over an upper end face of the filter;

FIG. 8 schematically shows two different resonator structures with a single-end grounding;

FIG. 9 show schematically shows various possible cross sections of the central resonator;

FIG. 10 schematically shows a filter according to an embodiment of the present disclosure;

FIG. 11 schematically shows a filter according to a second embodiment of the present disclosure;

FIG. 12 shows a performance curve of the filter;

FIG. 13 schematically shows several filters assembled on a PCB by SMT;

FIG. 14 schematically shows a TM mode resonator structure of the present disclosure, which comprises two central resonators;

FIG. 15 schematically shows TM mode resonator structures, each of which comprises two central resonators, with various structural forms in sectional views;

FIG. 16 schematically shows a filter comprising a dual-mode structure;

FIG. 17 schematically shows a filter comprising a triple-mode structure; and

FIG. 18 schematically shows various arrangements of the two different ceramic materials comprised in the second part.

### DETAILED DESCRIPTION

The embodiments of the present disclosure are described in detail with reference to the accompanying drawings. It should be understood that these embodiments are discussed only for the purpose of enabling those skilled in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. Those skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

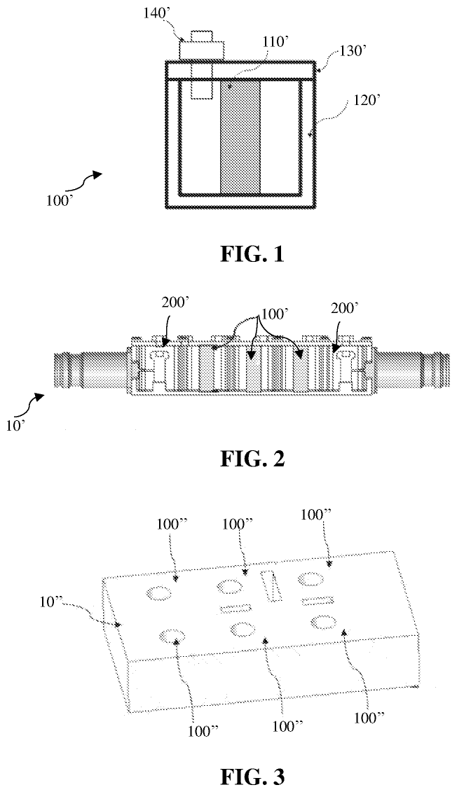

FIG. 1 schematically shows a single TM resonator structure 100′ included in a TM mode filter 10′ in the prior art. The TM mode resonator structure 100′ includes a metal housing 120′, a central ceramic part 110′ disposed in the metal housing, and a metal cover 130′ disposed on the metal housing, with a tuning screw 140′ extending through the cover 130′. In this resonator structure 100′, the central ceramic part 110′ is fixedly connected at one end to the bottom of the housing and at the other end to the bottom surface of the cover, thereby ensuring that both ends of the central ceramic part 100′ can be stably grounded. For example, the central ceramic part 110′ may be conductively connected to metal parts at the two ends by elastic crimping or welding, or the like.

However, in such designs, additional supports are often needed for stably holding and connecting the central ceramic part 110′. In addition, the ceramic material of the central part 110′ is brittle and has a large difference in thermal expansion coefficient, compared with the metal material to be connected or joined. This is disadvantageous in the application of mobile communication devices, such as cell phones, because large temperature variations occurred during different periods of a day, such as morning and evening, may cause large deformations at the joints between the metal and the ceramic materials having a large difference in the thermal expansion coefficient, eventually resulting in damages at the joints, such as welds and the like. Therefore, this greatly limits the widespread use and mass production of such designs. Referring to FIG. 2, a TM mode filter 10′ is composed of a plurality of TM mode resonator structures 100′ and two metal resonator structures 200′, each two adjacent cavities being coupled by a metal window. It can be seen that such a filter requires lots of additional components and is complex in overall construction. The filter shown in FIG. 2 has a small loss, but the overall structure is large in size and complicated.

In addition, FIG. 3 shows a prior art ceramic waveguide (CWG) filter 10″, the resonator structures 100″ forming as a ceramic block with a metallized surface. Such a CWG filter can have a reduced size but has a larger loss as compared to the TM mode filter shown in FIG. 2.

The present disclosure is therefore proposed to provide an improved resonator structure and a filter, which make it possible to achieve a smaller structural size and at the same time a smaller loss with an improved Q value.

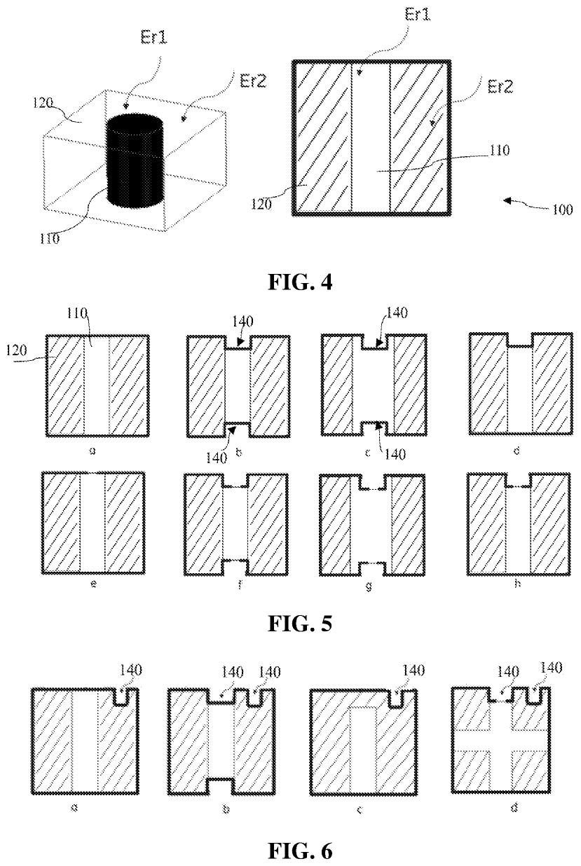

A TM mode resonator structure according to the present disclosure comprises at least two different dielectric materials having different dielectric constants, wherein the dielectric material having the larger dielectric constant is arranged centrally to function as a central resonator and the dielectric material having the smaller dielectric constant is arranged around the central resonator. Specifically, FIG. 4 shows in perspective and sectional views a TM mode resonator structure 100 according to an embodiment of the present disclosure, comprising two different ceramic materials. The TM mode resonator structure includes a first part 110 of a ceramic material having a first dielectric constant Er1 and a second part 120 arranged around the first part 110 and of a ceramic material having a second dielectric constant Er2, which is smaller than the first dielectric constant Er1. The first and second parts are bonded to each other to form a ceramic body in a single piece. For example, the first and second parts 110 and 120 may be sintered together, or sintered separately and then bonded to each other. The whole ceramic body is coated on its outer surface with a metallic material, such as silver plating. It should be understood that in addition to silver, copper or other suitable materials may be used as the metallic material for coating. It will of course be appreciated that the second part arranged around the first part may comprise one or more different ceramic materials having dielectric constant(s) which is/are less than that of the central resonator. For example, in addition to a first ceramic material with a first dielectric constant Er1 of the first part, two different kinds of ceramic materials (i.e., a second ceramic material and a third ceramic material) of lower dielectric constants Er2, Er3 may be comprised in the second part, wherein the second ceramic material may have various arrangements relative to the third ceramic material (referring to FIG. 18), e.g., the second and third ceramic materials may be arranged concentrically (see FIG. 18a), or arranged as two halves (see FIG. 18b), or arranged one above the other (see FIG. 18c) around the first part.

In this way, the structural dimensions of the filter can be reduced even further by replacing the air cavities of the prior art, which are not filled with any dielectric material, with ceramic material. More importantly, the second part 120 can be used for supporting and holding the first part 110 (since the two parts are bonded together), so that an additional support for the central resonator is omitted, and the problem of failure of a joint between the metal cover and the central ceramic part caused by a large difference of the two parts in thermal expansion coefficient in the prior art are avoided, thus facilitating the mass production of such a filter.

In the resonator structure as shown in FIG. 4, the upper end face and the lower end face of the first part 110 as a central resonator are formed as a part of the outer surface of the single piece, so as to achieve a two-end grounding. Of course, it is also possible that only one end face of the first part 110 is formed as a part of the outer surface of the single piece to achieve a single-end grounding (see FIG. 8). Referring to FIG. 9, the first part 110 may have a cross-section of various forms, such as a circle, a rectangle, a polygon, a cross, and the like. In addition, the cross-section of the first part 110 may be non-constant in the axial direction, as shown in FIG. 8b. It will be appreciated that other structural forms are possible as long as the intended functions herein are achieved.

In contrast to the filters known in the prior art, which are tuned by adopting tuning elements, such as tuning screws 140′, the filter of the present disclosure can be tuned by partially removing the metal material. Specifically, the frequency tuning may be achieved by partially removing the metal material on the first part 110 having a higher dielectric constant or on the second part 120 having a lower dielectric constant.

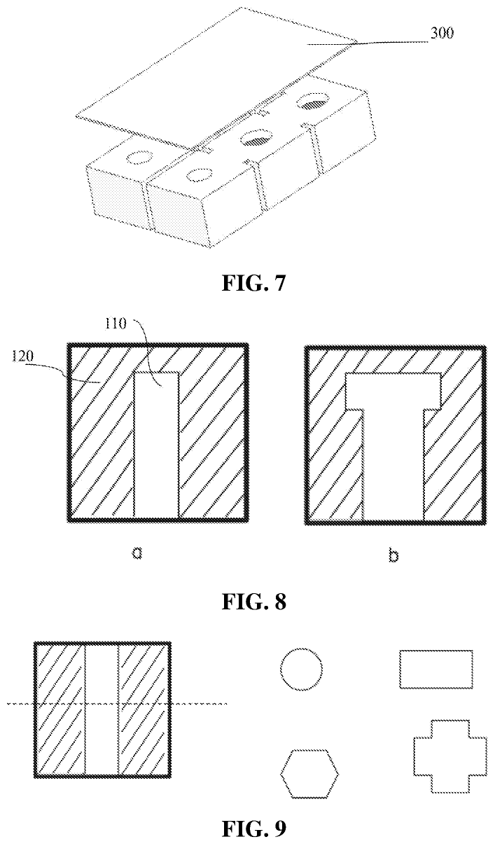

With continued reference to FIGS. 5 and 6, TM mode resonator structures having a variety of different structural forms are shown in sectional views. For example, as shown in FIG. 5c, recesses 140 may be provided at the upper and lower ends of the first part 110 (or a recess may be provided at only one of the two ends); as shown in FIGS. 6a-d, a recess 140 may be provided in the second part 120; as shown in FIGS. 5b and 5d, the first part 110 may be recessed at the upper and/or lower end relative to the second part 120 to form recess(s) 140 at the respective ends. The recess 140 is coated with a metallic material. In particular, referring to FIGS. 5f, 5g, and 5h, the metallic material on the recess 140 may be partially removed to form a metal-free region, so as to eliminate frequency deviation caused by production errors and/or tune the loading frequency of the filter, etc. After the tuning, a metallic shield 300 (see FIG. 7) may be disposed on the upper end face of the filter to realize EMC shielding.

In addition, for example considering the need to minimize the types of materials to be welded, a recess can be preferably provided in such a way on the lower end face of the single piece that only one kind of ceramic material is to be welded with the PCB, and the welding process difficulty is thus reduced.

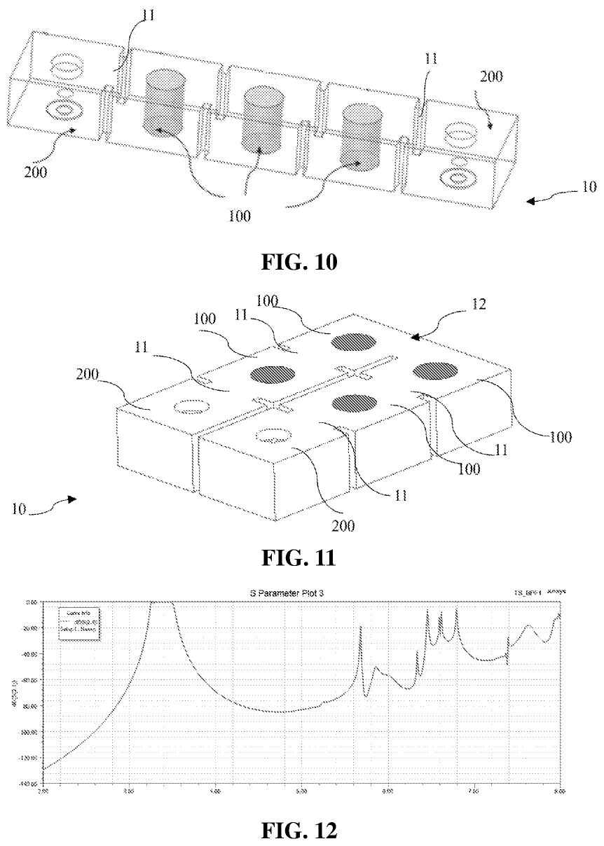

FIG. 10 shows a filter 10 according to an embodiment of the present disclosure, which comprises a plurality of (three as shown in the figure) TM mode resonator structures 100 and two ceramic waveguide structures 200. The ceramic waveguide structures 200 can serve as a signal feed-in and a signal feed-out, respectively, and also facilitate optimization of distant harmonics. In the filter 10 shown in FIG. 10, three TM mode resonator structures 100 and two ceramic waveguide structures 200 are in a linear arrangement, the three TM mode resonator structures being located between the first and second ceramic waveguide structures, wherein adjacent two of the TM mode resonator structures 100 and ceramic waveguide structures 200 are coupled with each other via a coupling window 11 of a ceramic material.

FIG. 11 shows a filter according to another embodiment of the present disclosure, which, in contrast to the filter shown in FIG. 10, comprises two rows of TM resonator structures 100 coupled via a connecting portion 12 of the ceramic material, wherein the first ceramic waveguide structure is coupled with one of a first row of TM mode resonator structures and the second ceramic waveguide structure is coupled with one of a second row of TM mode resonator structures. The filter in this design can be matched better to the existing antenna products developed by the applicant. Of course, filters with other arrangements are also possible as long as the intended functions herein can be achieved. In the filter shown in FIG. 11, the adjacent two structures are coupled by the coupling window 11 of the ceramic material.

The filter, as shown in FIGS. 10-11, may be formed as a single ceramic block, the coupling window 11 being a lateral recess formed in the single ceramic block, and the lateral recessing depth of the lateral recess determining the size of the coupling window 11, which in turn determines the transmitted energy.

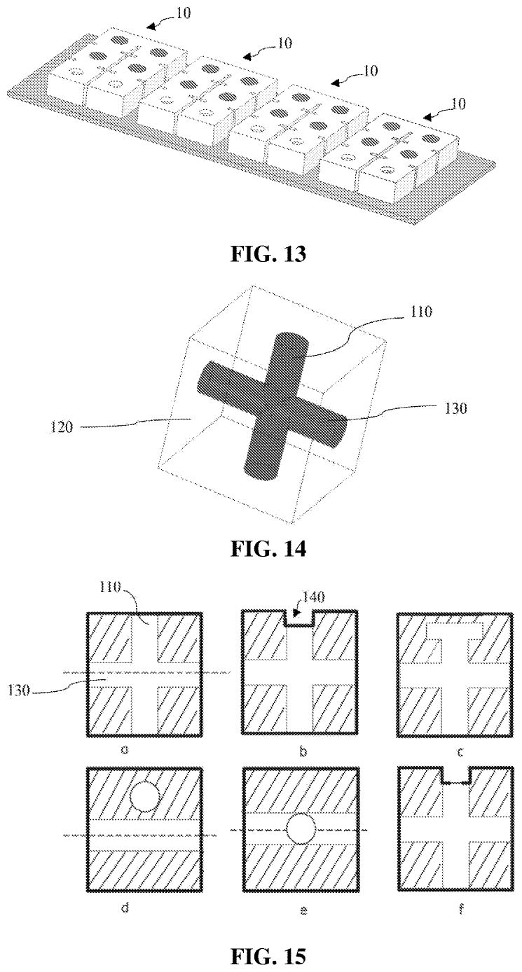

The filter 10 according to the present disclosure can be easily attached to a PCB by SMT, as shown in FIG. 13. Compared with the prior art, the filter of the present disclosure can have a lower insertion loss with an unchanged structural size. Furthermore, as can be seen from the performance curve shown in FIG. 12, the stop band of the filter is steep, and an improved performance is obtained by such a filter.

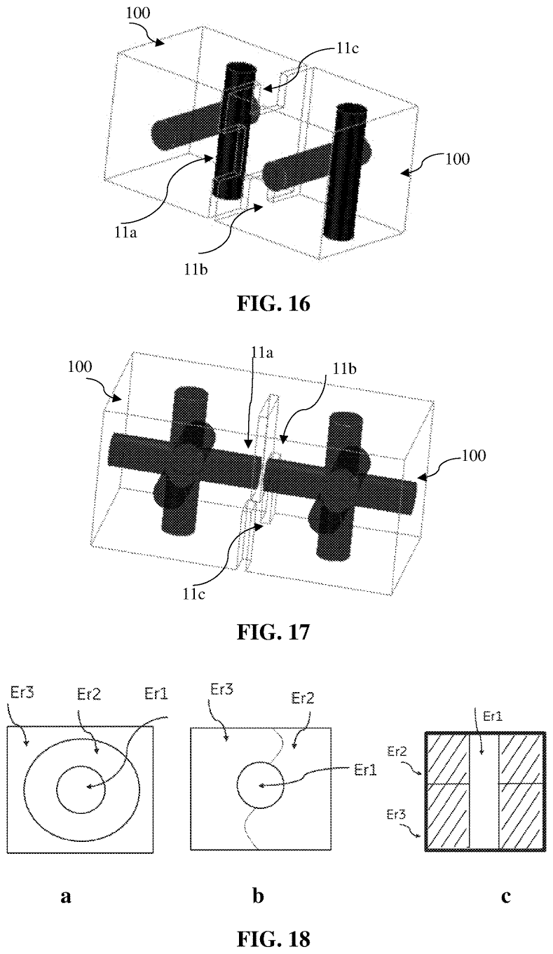

To further optimize the performance of the filter, on the basis of the resonator structure shown in FIG. 4, a second resonator 130 (see FIG. 14) may be provided, which is substantially orthogonal to the first part 110 as the first resonator. FIG. 15 shows various structural forms of a TM mode resonator comprising two resonators, wherein the two resonators may be crossed (see FIGS. 15a-c and 15e-f) or not crossed (FIG. 15d) with each other. As illustrated in the embodiment shown in FIG. 16, two resonator structures 100, each comprising two resonators orthogonal to each other, are coupled via the coupling windows 11a, 11b and 11c.

If the resonator structures comprised in the filter shown in FIG. 10 are replaced with the resonator structures each comprising two resonators (i.e., a dual mode structure), the original three cavities can be extended into six cavities, and thus the original Fifth-order filter becomes an Eighth-order filter.

Further, in addition to the two orthogonal resonators, it is also conceivable to provide a third resonator substantially orthogonal to the two resonators (i.e., a triple mode structure), which makes it possible to achieve a filter of more orders and thus a better filter performance with an unchanged structural size. As illustrated in the embodiment shown in FIG. 17, two resonator structures 100, each comprising three resonators orthogonal to each other, are coupled via the coupling windows 11a, 11b and 11c.

It will be appreciated that each of the above-described features/aspects of the TM mode resonator structure with a single resonator and/or the combinations thereof can also be comprised in a dual mode structure and a triple mode structure.

The filter according to the present disclosure can be widely used in AAS systems, since it has a simpler and more compact structure (i.e., a reduced size), a better performance (e.g., higher Q value and lower loss), comprises fewer components, and is easier to realize a SMT assembly, thus overcoming one or more of the drawbacks of the resonator structures known in the prior art.

References in the present disclosure to “an embodiment”, “a specific embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, and/or “comprised”, when used herein, specify the presence of stated features, elements, and/or components, but do not preclude the presence or addition of one or more other features, elements, components and/or combinations thereof. The terms “coupled to” and/or “coupled with” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A TM mode resonator structure comprising at least two kinds of dielectric materials having different dielectric constants, a first part of a first dielectric material constituting a first resonator, which is surrounded by a second part of at least a second dielectric material, the dielectric constant of the first dielectric material being greater than the dielectric constant of the second dielectric material, the first and second parts being bonded with each other into a single piece, the outer surface of which is coated with a metal material.

2. The TM mode resonator structure as claimed in claim 1, wherein the at least two kinds of dielectric materials are ceramic materials.

3. The TM mode resonator structure as claimed in claim 1, wherein one or both of an upper end face and a lower end face of the first part is/are formed as part of the outer surface of the single piece and coated with the metal material, to provide a single-end grounding or a two-end grounding.

4. The TM mode resonator structure as claimed in claim 1, wherein a recess coated with the metal material is provided on an upper end face and a lower end face of the single piece.

5. The TM mode resonator structure as claimed in claim 4, wherein the recess is formed in the first part and the second part.

6. The TM mode resonator structure as claimed in claim 4, wherein the first part is recessed at one or both of the upper and lower end relative to the second part to form the recess the recess being delimited by the first and second parts.

7. The TM mode resonator structure as claimed in claim 1, wherein the metal material on one or both of an upper end face and a lower end face of the single piece is partially removed to form a metal-free region.

8. The TM mode resonator structure as claimed in claim 1, wherein a cross-section of the first part as the first resonator has a shape selected from a circle, a polygon, or a cross.

9. The TM mode resonator structure as claimed in claim 1, further comprising a second resonator, wherein the second resonator and the first resonator are substantially orthogonal to each other.

10. The TM mode resonator structure as claimed in claim 9, wherein the second resonator is made of a material which is the same as or different from the first dielectric material.

11. The TM mode resonator structure as claimed in claim 9, further comprising a third resonator, the first, second and third resonators being substantially orthogonal to one another.

12. The TM mode resonator structure as claimed in claim 11, wherein the third resonator is made of a material which is the same as or different from the first dielectric material.

13. The TM mode resonator structure as claimed in claim 1, wherein the metal material is silver or copper.

14. A filter comprising:
a plurality of TM mode resonator structures each of the plurality of TM mode resonator structures comprising at least two kinds of dielectric materials having different dielectric constants, a first part of a first dielectric material constituting a first resonator, which is surrounded by a second part of at least a second dielectric material, the dielectric constant of the first dielectric material being greater than the dielectric constant of the second dielectric material, the first and second parts being bonded with each other into a single piece, the outer surface of which is coated with a metal material; and
two ceramic waveguide structures, adjacent two of the TM mode resonator structures and ceramic waveguide structures being coupled with each other via a coupling window, the first ceramic waveguide structure serving as a signal feed-in and the second ceramic waveguide structure serving as a signal feed-out.

15. The filter as claimed in claim 14, wherein a metallic shield is disposed over an upper end face of the filter

16. The filter as claimed in claim 14, wherein the ceramic waveguide structures and the TM mode resonator structures are in a linear arrangement, the plurality of TM mode resonator structures being located between the first and second ceramic waveguide structures.

17. The filter as claimed in claim 14, wherein the filter comprises at least two rows of TM mode resonator structures coupled via a connecting portion wherein the first ceramic waveguide structure is coupled with one of a first row of TM mode resonator structures and the second ceramic waveguide structure is coupled with one of a second row of TM mode resonator structures.

18. A duplexer comprising at least one filter, each of the at least one filter comprising:
a plurality of TM mode resonator structures, each of the plurality of TM mode resonator structures comprising at least two kinds of dielectric materials having different dielectric constants, a first part of a first dielectric material constituting a first resonator, which is surrounded by a second part of at least a second dielectric material, the dielectric constant of the first dielectric material being greater than the dielectric constant of the second dielectric material, the first and second parts being bonded with each other into a single piece, the outer surface of which is coated with a metal material; and
two ceramic waveguide structures, adjacent two of the TM mode resonator structures and ceramic waveguide structures being coupled with each other via a coupling window, the first ceramic waveguide structure serving as a signal feed-in and the second ceramic waveguide structure serving as a signal feed-out.

19. (canceled)

20. (canceled)

21. The duplexer as claimed in claim 18, wherein a metallic shield is disposed over an upper end face of the filter.

22. The duplexer as claimed in claim 18, wherein the ceramic waveguide structures and the TM mode resonator structures are in a linear arrangement, the plurality of TM mode resonator structures being located between the first and second ceramic waveguide structures.
